(19) United States
(12) Patent Application Publication
(10) Pub. No.: US 2020/0192008 A1
(43) Pub. Date: Jun. 18, 2020

(54) INCIDENT ANGEL AND POLARIZATION INDEPENDENT ULTRATHIN BROADBAND PERFECT ABSORBERS

(71) Applicant: KOREA ADVANCED INSTITUTE OF SCIENCE AND TECHNOLOGY, Daejeon (KR)

(72) Inventors: Kyoungsik Yu, Daejeon (KR); Yeonghoon Jin, Daejeon (KR); Junghoon Park, Daejeon (KR); Yoonhyuk Rah, Daejeon (KR); Jaeho Shim, Daejeon (KR)

(21) Appl. No.: 16/710,097

(22) Filed: Dec. 11, 2019

(30) Foreign Application Priority Data
Dec. 12, 2018 (KR) 10-2018-0159857

(51) Int. Cl. G02B 5/00

(52) U.S. Cl. CPC G02B 5/003

(57) ABSTRACT

The present disclosure relates to an incident angle and polarization independent ultrathin broadband perfect absorber including a reflective layer, an active layer formed on the reflective layer, and an impedance matching layer formed on the active layer, wherein the absorber almost completely absorbs light in a wavelength range of 400-800 nm.

### CROSS-REFERENCE TO RELATED APPLICATION

This application claims priority of Korean Patent Application No. 10-2018-0159857, filed on Dec. 12, 2018, in the KIPO (Korean Intellectual Property Office), the disclosure of which is incorporated herein entirely by reference.

### BACKGROUND OF THE INVENTION

### Field of the Invention

The present disclosure relates to incident angle and polarization independent ultrathin broadband perfect absorbers exhibiting high absorption in wider bandwidths.

### Description of the Related Art

U.S. Pat. No. 9,952,096 provides a device comprising a reflector that is reflective at the working wavelength of λ, and a dielectric layer disposed over the reflector, wherein a refractive index of the dielectric layer is n, and an extinction coefficient k of the dielectric layer is equal to or greater than 0.5, and a thickness h of the dielectric layer is less than λ/4n such that the reflector and the dielectric layer form a resonator at A.

As opposed to earlier antireflection coatings having the thickness of λ/4, beyond the common thought, the antireflection coating of U.S. Pat. No. 9,952,096 exhibits very low reflectance (high absorption) at the thickness (˜20 nm) that is much less than λ/4, using a highly lossy semiconductor material (Ge)/metal (Au) structure as shown in FIG. 1. This method has not only an ultrathin advantage but also a big advantage that it is insensitive to incident angle and polarization as opposed to the earlier antireflection coatings.

Accordingly, as shown in FIG. 2, these properties are used in coloring applications. The use of ultrathin germanium (Ge) provides coating in various colors at a very low cost.

U.S. Pat. No. 9,952,096 focuses on coloring, while the present disclosure focuses on optical devices (solar cells and optical sensors).

The use in optical device applications requires high absorption in the wide wavelength range, and incident angle and polarization independency.

U.S. Pat. No. 9,952,096 only exhibits very high absorption (low reflectance) at a specific wavelength, and this is because of poor impedance matching with air due to a high refractive index of germanium (Ge).

### SUMMARY OF THE INVENTION

The present disclosure is designed to solve the above-described problem, and therefore the present disclosure is directed to providing incident angle and polarization independent ultrathin broadband perfect absorbers exhibiting high absorption in wider bandwidths.

The object of the present disclosure is not limited to the above mentioned object, and other objects not mentioned herein will be clearly understood by those having ordinary skill in the art from the following disclosure.

As a solution to the above-described problem, according to an embodiment of the present disclosure, there is provided an incident angle and polarization independent ultrathin broadband perfect absorber including a reflective layer, an active layer formed on the reflective layer, and an impedance matching layer formed on the active layer, wherein the absorber absorbs light in a wide wavelength range of 400-800 nm.

The impedance matching layer may absorb light having an incident angle of 0 to ±60°, and may be polarization independent.

The impedance matching layer may protect the active layer from air, thereby improving electrical properties of the active layer.

The incident angle and polarization independent ultrathin broadband perfect absorbers according to the present disclosure ensure higher absorption in wider bandwidths by using the impedance matching layer.

Furthermore, it is possible to achieve a process cost reduction without the need for a complicated process such as nano patterning with a thickness that is less than λ/4 of the related art.

Moreover, due to incident angle and polarization independency, it is expected that the absorbers will have high efficiency when used in optical device applications, such as solar cells.

In addition, the impedance matching layer serves to increase absorption and protect (passivation) the active layer that generates charge carriers from the outside, thereby reducing charge carrier losses on the surface, and hence obtaining high electrical properties.

Besides, it is possible to apply the same method to not only the active layer made of germanium (Ge) but also a variety of highly lossy semiconductors such as molybdenum disulfide (MoS2).

### BRIEF DESCRIPTION OF THE DRAWINGS

The above and other features and advantages will become more apparent to those of ordinary skill in the art by describing in detail exemplary embodiments with reference to the attached drawings, in which:

FIGS. 1 and 2 are diagrams illustrating an absorber according to the related art.

FIG. 3 is a diagram showing the structure of an incident angle and polarization independent ultrathin broadband perfect absorber according to an embodiment of the present disclosure.

FIG. 4 is a diagram illustrating wavelength based light absorption capability of an absorber according to an embodiment of the present disclosure.

FIG. 5 is a diagram illustrating angle and polarization based light absorption capability of an absorber according to an embodiment of the present disclosure.

FIG. 6 is a diagram showing an example of an absorber of the present disclosure applied to MoS₂.

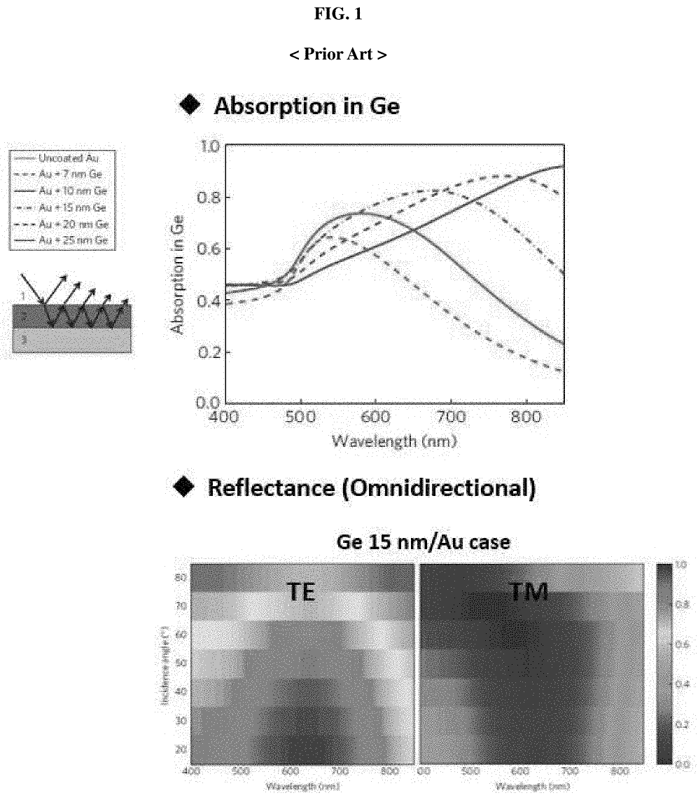

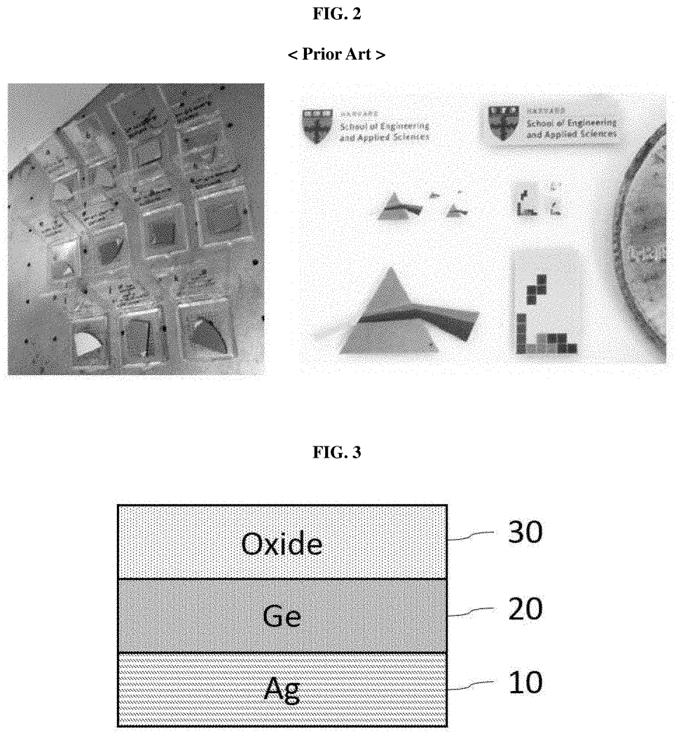

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

FIG. 3 is a diagram showing an incident angle and polarization independent ultrathin broadband perfect absorber according to an embodiment of the present disclosure.

Referring to FIG. 3, the incident angle and polarization independent ultrathin broadband perfect absorber of the present disclosure includes a reflective layer 10, an active layer 20 formed on the reflective layer and an impedance matching layer 30 formed on the active layer.

That is, the present disclosure theoretically and experimentally realizes an absorber exhibiting higher absorption than the existing absorber (black line) by using the impedance matching layer (oxide).

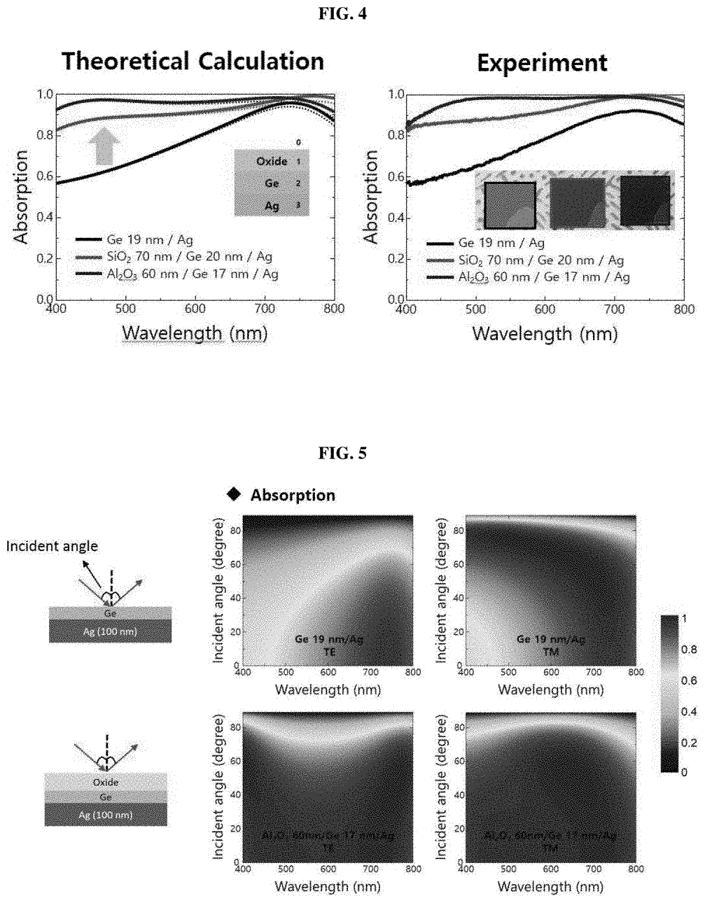

Referring to FIG. 4, it can be theoretically and experimentally seen that the absorber of the present disclosure absorbs most of light at 400-800 nm.

Advantageously, the impedance matching layer 30 is thinner about twice than the existing antireflection coating having the thickness of λ/4.

Additionally, the impedance matching layer increases absorption and when used in a real device, protects germanium (Ge) in the active layer 20 that generates charge carriers and reduces charge carrier losses on the surface, thereby improving the electrical properties.

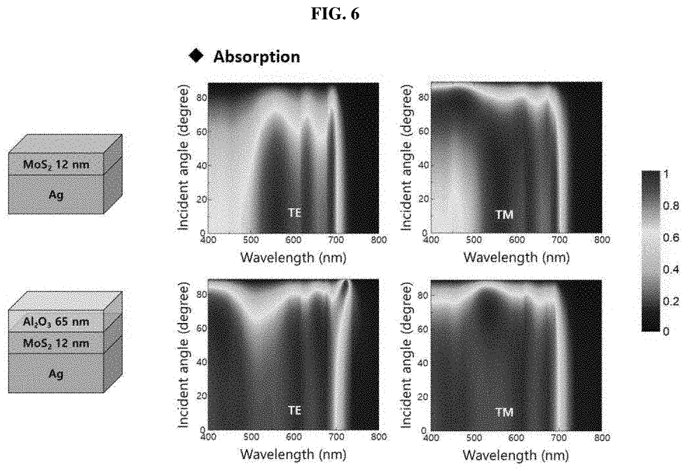

Additionally, referring to FIG. 5, it can be seen that the absorber of the present disclosure exhibits higher absorption in much wider bandwidths than the existing two-layer absorber.

Particularly, it can be seen that the absorber of the present disclosure maintains very great absorption not only at an incident angle (0°) corresponding to vertical incidence but also at a high incident angle (˜60°), and is polarization independent.

Advantageously, the absorber described above is applicable to not only Ge but also a variety of highly lossy and high refractive index semiconductors.

FIG. 6 is a diagram showing an example of the absorber of the present disclosure applied to MoS2. That is, an oxide such as Al2O3 is coated on a layer of MoS2 to obtain the previously described effect

FIG. 6 is a diagram showing an example of the absorber of the present disclosure applied to MoS₂. That is, an oxide such as Al₂O₃ is coated on a layer of MoS₂ to obtain the previously described effect.

As described above, the present disclosure realizes the absorber exhibiting high absorption in broadband by using the impedance matching layer.

This achieves a process cost reduction without the need for a complicated process such as nano patterning with a thickness that is less than λ/4 of the related art.

Furthermore, due to incident angle and polarization independency, it is expected that the absorber will have high efficiency when used in optical device applications such as solar cells.

In addition, the impedance matching layer serves to increase absorption and protect (passivation) the active layer that generates charge carriers from the outside, thereby obtaining high electrical properties.

Besides, it is possible to apply the same method to not only the active layer made of germanium (Ge) but also a variety of highly lossy semiconductors (MoS₂).

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An incident angle and polarization independent ultrathin broadband perfect absorber, comprising:
a reflective layer;
an active layer formed on the reflective layer; and
an impedance matching layer formed on the active layer,
wherein the absorber absorbs light in a wavelength range of 400-800 nm.

2. The incident angle and polarization independent ultrathin broadband perfect absorber of claim 1, wherein the absorber absorbs light having an incident angle of 0 to ±60°, and is polarization independent.

3. The incident angle and polarization independent ultrathin broadband perfect absorber of claim 1, wherein the impedance matching layer protects the active layer and reduces a charge carrier loss on a surface, thereby improving electrical properties of the active layer
